(19) United States
(12) Patent Application Publication
(10) Pub. No.: US 2014/0170288 A1
(43) Pub. Date: Jun. 19, 2014

(54) NO SUGAR CONFECTIONERS BLEND COMPOSITION

(71) Applicant: Teodor Gelov, Carmel, IN (US)

(72) Inventor: Teodor Gelov, Carmel, IN (US)

(73) Assignee: TC HEARTLAND LLC, Carmel, IN (US)

(21) Appl. No.: 14/131,733

(22) PCT Filed: Jul. 14, 2011
(86) PCT No.: PCT/US2011/044037

§ 371 Date: Jan. 9, 2014

(51) Int. Cl. A23L 1/236

(52) U.S. Cl. CPC A23L 1/2364
USPC 426/548

(57) ABSTRACT

Disclosed is a no-sugar sweetener composition containing a sugar alcohol such as xylitol, a high intensity sweetener such as sucralose, a starch, and a carbohydrate carrier such as maltodextrin. The sweetener composition, which has fewer calories than sugar or confectioners sugar, has the same look, taste, texture, and flowability of confectioners sugar and can be used in a variety of no-sugar food products such as cookies, cakes, icings and the like.

### BACKGROUND OF THE INVENTION

People crave sweet foods and drinks, however, natural sweeteners, such as sugar, have a high caloric content and lead to weight gain when consumed in large amounts. Moreover, people with certain medical conditions, such as various forms of diabetes, must severely limit their sugar intake. In order to overcome these problems, researchers have been looking for sweetener compositions with very low caloric content, that are sweet but otherwise have a neutral taste and can be readily used in food stuff

Confectioners sugar or powdered sugar, also known as icing sugar in the UK, or sucre glace in France, is granulated sugar ground to a smooth powder and then sifted. It contains about 3% corn starch to prevent caking Powdered sugar is ground into three different degrees of fineness. The confectioners sugar available in the supermarket is typically 10×, which is the finest of the three grades and is used in icings, confections, and whipping creams. The other two types are used in by industrial bakers. One cup of commercially available powdered sugar weighs 120 grams and has a total calorie content of 466 calories (kcal), which is rather high. Accordingly, attempts have been made to reduce the caloric content of the confectioners sugar and to reduce the amount of sugar used in baking and confectionary.

Intense sweetening agents are natural or synthetic compounds, which have a sweetening intensity greater than sugar and which typically have a caloric value lower than sugar. Examples of intense sweetening agents include saccharin, cyclamate, acesulfame-K, proteins such as thaumatin, chlorodeoxysugar derivatives (e.g., sucralose), aspartame, alitame, and the like. Because intense sweeteners provide greater sweetening capacity than sugar, smaller amounts of intense sweeteners will provide sweetening intensity equivalent to larger amounts of sugar. Accordingly, intense sweeteners are widely used in place of sugar in many low calorie compositions. Intense sweeteners can provide compositions that have decreased caloric value as compared to sugar-sweetened compositions because far lower amounts of the intense sweetener are required to achieve optimum sweetness in the composition.

Attempts have been made to prepare lower calorie confectioners blend composition that will substitute confectioners sugar but provide a lower calorie alternative to sugar. However, there still exists an unmet need for an alternative that is no sugar and lower or low-calorie and that uniquely combines the look, taste, texture, and flowability of confectioners sugar.

### BRIEF SUMMARY OF THE INVENTION

The invention provides a sweetener composition that contains no sugar and has lower or low-calorie and uniquely combines the same or substantially the same look, taste, texture, and flowability of confectioners sugar. The no-sugar composition comprises, consists essentially of, or consists of a sugar alcohol, a high intensity sweetener, a starch, and a carrier selected from the group consisting of maltodextrin, dextrose, and combinations thereof. The no sugar sweetener composition has fewer calories than sugar or confectioners sugar.

The sweetener composition of the invention has the equivalent volume to confectioners sugar and the thermal stability such that it may be used in baking applications. The no-sugar composition of the invention has a caloric value of less than 8 calories per teaspoon or less than 384 calories per cup. In addition to providing lower caloric content, the composition can provide one or more of the following advantages: very low relative glycemic response, dental benefits, reduced need for antibiotics in patients undergoing antibiotic treatments, prebiotic effect, and/or prevention of acute otitis media.

### DETAILED DESCRIPTION OF THE INVENTION

The invention is directed to a no-sugar and lower or low-calorie sweetener composition comprising a sugar alcohol in combination with a high intensity sweetener, a starch, and a carrier. In embodiments, the sweetener composition consists essentially of a sugar alcohol (e.g., xylitol), a high intensity sweetener, corn starch, and a carrier selected from the group consisting of maltodextrin, dextrose, and combinations thereof. In certain embodiments, the sweetener composition consists of a sugar alcohol (e.g., xylitol), sucralose, corn starch, and a carrier, for example, maltodextrin.

In some embodiments, the sweetener composition is a bulk sweetener composition, which can be used as a 1:1 volume confectionary substitute for sugar.

The sweetener composition is a no-sugar lower or low-calorie composition.

The sweetener composition comprises any suitable high intensity sweetener. Examples of high intensity sweeteners include sucralose, acesulfame potassium and other salts, aspartame, alitame, saccharin, neohesperidin dihydrochalcone, cyclamate, neotame, stevioside/rebaudioside A, thaumatin, mogroside (or Lo han guo), N-[N-[3-(3-hydroxy-4-methoxyphenyl)propyl]-L-α-aspartyl]-L-α-phenylalanine 1-methyl ester, N-[N-[3-(3-hydroxy-4-methoxyphenyl)-3-methylbutyl]-L-α-aspartyl]-α-phenylalanine 1-methyl ester, N-[N-[3-methoxy-4-hydroxyphenyl)propyl]-L-α-aspartyl]-L-α-phenylalanine 1-methyl ester, salts thereof, and combinations thereof, preferably sucralose. Sucralose (4,1′,6′-trichloro-4,1′,6′-trideoxygalactosugar) is a sweetener with a sweetness intensity approximately 600 times that of sugar. Sucralose also compares favorably with sucrose (sugar) in high quality sweetness with no bitter aftertaste or metallic notes. It can also blended with other sweeteners. Sucralose has zero caloric content.

Typically the sweetener composition comprises about 0.01% to about 1%, e.g., about 0.02% to about 0.08%, and in embodiments, about 0.04% to about 0.06%, of the high intensity sweetener, particularly sucralose, based on the total weight of the composition.

The sweetener composition of the invention comprises a starch, which can be any suitable starch, e.g., starches obtained from seeds, particularly corn, waxy corn, high amylase corn, wheat, and rice, and from tubers or roots such as potato, sweet potato, and tapioca (cassava). The starch can be present in the sweetener composition in any suitable amount, for example, about 5 to about 20%, and in certain embodiments, about 7 to 15%, and in certain other embodiments, about 8 to about 10%, based on the total weight of the composition.

The sugar alcohol, according to the invention, is a polyol derived from a carbohydrate whose carbonyl group (aldehyde or ketone) has been reduced to a primary or secondary hydroxyl group. Sugar alcohols can be classified by chemical structure as monosaccharide-derived, disaccharide-derived, or polysaccharide-derived mixtures. The sugar alcohol can be any suitable polyol, for example a polyol selected from the group consisting of sorbitol, mannitol, maltitol, erythritol, xylitol, lactitol, palatinit, and combinations thereof. Preferably the sugar alcohol is a monosaccharide-derived polyol selected from sorbitol, mannitol, xylitol, and erythritol. More preferably, the sugar alcohol is xylitol. In some embodiments, the sweetener composition comprises, consists essentially of, or consists of, sucralose, xylitol, starch, and the carrier.

The amount of sugar alcohol used in the sweetener composition can be any suitable amount. Typically, the amount of sugar alcohol is between about 50% to about 80%, preferably about 60% to about 70%, or about 62% to about 64%, based on the total weight of the composition.

The carrier is a carbohydrate carrier selected to provide bulk to dry mix compositions with minimum density. Typically the carrier is a carbohydrate carrier selected from the group consisting of maltodextrin, dextrose, and combinations thereof. The sweetener composition preferably comprises maltodextrin (e.g., where the maltodextrin is M100, which has a bulk density of about 0.13 g/cm³). Maltodextrins are starch hydrolysis products having a degree of hydrolysis or dextrose equivalent of less than 20. They are generally produced by the action of an amylase enzyme on gelatinized starch., which removes at least some of the α-1,4-glucose linkages. Maltodextrin contains a range of non-sweet polysaccharides with a distribution of molecular weights where the anhydroglucose units are linked predominantly by 1,4-bonds.

The amount of carbohydrate carrier used in the sweetener composition can be any suitable amount. Typically, the amount of carbohydrate carrier is about 20% to about 40%, e.g., about 25% to about 30%, or about 26% to about 28%, based on the total weight of the composition.

In an embodiment, the low-calorie sweetener composition of the invention consists essentially of about 50 to about 80 wt. % sugar alcohol, about 0.01 to about 1 wt. % high intensity sweetener, about 5 to about 20% starch, and about 20 to about 40 wt. % of the carrier.

In another embodiment, the low-calorie sweetener composition of the invention consists essentially of about 60 to about 70 wt. % sugar alcohol, about 0.02 to about 0.08 wt. % high intensity sweetener, about 7 to about 15% starch, and about 25 to about 30 wt. % carrier.

In a further embodiment, the low-calorie sweetener composition of the invention consists essentially of about 62 to about 64 wt. % sugar alcohol, about 0.04 to about 0.06 wt. % high intensity sweetener, about 8 to about 10% starch, and about 26 to about 28 wt. % carrier.

The low-calorie sweetener composition of the invention has a powder flowability and consistency similar to commercially available confectioners sugar, for example, 10× confectioners sugar.

The foregoing compositions may be made by any suitable processes. In some embodiments, the sweetener composition of the invention is prepared by dry blending, e.g., using a conventional paddle blender or twin shell V blender and/or other suitable blender, many of which are known in the art. Thus, for example, milled xylitol is dry mixed with M100 maltodextrin, corn starch and sucralose to obtain an embodiment of the sweetener composition of the invention. In an embodiment, the xylitol used has a particle size less than 500 μm, for example, less than 300 μm, less than about 200 μm, or less than about 100 μm, e.g., as determined by the RO-TAP method: residue on 500 microns sieve, 1% max; residue on 250 microns sieve, 10% max; and residue on 100 microns sieve, 70% max.

The low-calorie sweetener composition of the invention can optionally include additional ingredients such as flavorants, colorants, anti-flatulent agents, taste or sweetness enhancers, and the like.

The no sugar sweetener composition of the invention can find use in a variety of food products such as lower calorie cookies, powdered sugar frostings, fillings, glazes, party cakes, pound cakes, cut-outs, pancakes, biscuits, baked goods, doughnuts, cinnamon rolls, pies, butter cream, whip cream, and the like.

The sweetener composition of the invention has the same sweetness taste as confectioners sugar; it dissolves rapidly in water and in the mouth as confectioners sugar. It has the same fine texture as the confectioners sugar.

The sweetener composition of the invention has a particle size of about 5 μm to about 30 μm or more, and in embodiments, about 10 μm to about 20 μm, e.g., about 8, about 9, about 10, about 11, about 12, about 13, about 14, or about 15 μm. The fine size of the particles gives a smoother mouth-feel in food products, e.g., fillings and icing.

Since the sweetener composition of the invention, in embodiments, contain xylitol, it reduces the need for antibiotics, for example, those who consume the equivalent of 5-6 grams xylitol/day can lower their intake of antibiotics as much as by 30%.

In embodiments, the sweetener composition of the invention can provide a xylitol content of 1 to 2.3 grams per teaspoon, and in an embodiment, 1 to 1.5 grams per teaspoon, and in another embodiment, 1.1 gram per teaspoon.

The sweetener composition of the invention is free of sugar. It is also free of a gum base, emulsion stabilizer, or an elastomer.

The no sugar sweetener composition has a powder flowability equal to or almost equal to that of commercially available confectioners sugar.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A no-sugar sweetener composition comprising, consisting essentially of, or consisting of, a sugar alcohol, a high intensity sweetener, a starch, and a carrier selected from the group consisting of maltodextrin, dextrose, and combinations thereof

2. The no-sugar sweetener composition of claim 1, wherein the high intensity sweetener is sucralose.

3. The no-sugar sweetener composition of claim 1, wherein the sugar alcohol is xylitol.

4. The no-sugar sweetener composition of claim 1, wherein the starch is corn starch.

5. The no-sugar sweetener composition of claim 1, which consists essentially of about 50 to about 80 wt. % sugar alcohol, about 0.01 to about 1 wt. % high intensity sweetener, about 5 to about 20% starch, and about 20 to about 40 wt. % of the carrier.

6. The no-sugar sweetener composition of claim 1, which consists essentially of about 60 to about 70 wt. % sugar alcohol, about 0.02 to about 0.08 wt. %) high intensity sweetener, about 7 to about 15% starch, and about 25 to about 30 wt. % carrier.

7. The no-sugar sweetener composition of claim 1, consists essentially of about 62 to about 64 wt. % sugar alcohol, about 0.04 to about 0.06 wt. %) high intensity sweetener, about 8 to about 10% starch, and about 26 to about 28 wt. % carrier.

8. The no-sugar sweetener composition of claim 1, wherein the high intensity sweetener is sucralose, the sugar alcohol is xylitol, the starch is corn starch, and the carrier is maltodextrin.

9. The no-sugar sweetener composition of claim 8, wherein the sucralose is affixed to the maltodextrin.

10. The no-sugar sweetener composition of claim 1, which has a powder flowability of confectioners sugar.

11. The no-sugar sweetener composition of claim 5, wherein the high intensity sweetener is sucralose, the sugar alcohol is xylitol, the starch is corn starch, and the carrier is maltodextrin.

12. The no-sugar sweetener composition of claim 6, wherein the high intensity sweetener is sucralose, the sugar alcohol is xylitol, the starch is corn starch, and the carrier is maltodextrin.

13. The no-sugar sweetener composition of claim 7, wherein the high intensity sweetener is sucralose, the sugar alcohol is xylitol, the starch is corn starch, and the carrier is maltodextrin.

14. The no-sugar sweetener composition of claim 11, wherein the sucralose is affixed to the maltodextrin.

15. The no-sugar sweetener composition of claim 12, wherein the sucralose is affixed to the maltodextrin.

16. The no-sugar sweetener composition of claim 13, wherein the sucralose is affixed to the maltodextrin.
